(19) United States
(12) Patent Application Publication
(10) Pub. No.: US 2026/0023791 A1
(43) Pub. Date: Jan. 22, 2026

(54) ARTIFICIAL INTELLIGENCE GENERATED TEXT DETECTOR

(71) Applicant: GPTZero, Inc., Toronto (CA)

(72) Inventors: Alexander Yuhao CUI, Toronto (CA); George Alexandru ADAM, Stouffvile (CA); Edwin THOMAS, Toronto (CA); Nazar SHMATKO, Toronto (CA); Emily NAPIER, Toronto (CA); Edward Jingyuan TIAN, New York, NY (US)

(73) Assignee: GPTZero, Inc., Toronto (CA)

(21) Appl. No.: 19/274,411

(22) Filed: Jul. 18, 2025

Related U.S. Application Data
(60) Provisional application No. 63/673,492, filed on Jul. 19, 2024.
(60) Provisional application No. 63/837,572, filed on Jul. 2, 2025.

(51) Int. Cl. G06F 16/93; G06F 18/2415

(52) U.S. Cl. CPC G06F 16/93; G06F 18/2415

(57) ABSTRACT

Artificial intelligence generated text detector includes performing operations that include obtaining an input document, parsing the input document into tokens, generating, by an embedding model, token embeddings for the tokens, and aggregating the token embeddings across the input document to obtain a document embedding. The operations further include performing, by a document prediction model processing the document embedding, a document level classification to obtain a set of document class probabilities including an AI generated probability, a mixed probability, and a human generated probability. The operations further include presenting the set of document class probabilities.

### CROSS-REFERENCE TO RELATED APPLICATIONS

This application is a non-provisional application of, and thereby claims benefit under 35 U.S.C. § 119 (e) to U.S. Provisional Patent Application No. 63/673,492 filed on Jul. 19, 2024, and to U.S. Provisional Patent Application No. 63/837,572 filed on Jul. 2, 2025. U.S. Provisional Patent Application No. 63/673,492 and U.S. Provisional Patent Application No. 63/837,572 are incorporated herein by reference in their entirety.

### BACKGROUND

Text is the most frequently used technique to disseminate ideas. Historically, one of the biggest concerns is plagiarism. Namely, a human writer copies text or ideas of another and presents the copying of the ideas as the writer's own ideas and text. Plagiarism has been a problem in the academic setting when the human writer is to be graded or otherwise evaluated. Furthermore, plagiarism takes the credit of the original author without providing just compensation or due credit for the original author's work.

With the advent of generative artificial intelligence (AI) models, such as large language models (LLMs), the problems of plagiarism are more detrimental. Specifically, not only can the original author not be fairly evaluated, but also generative AI models commonly produce hallucinations. Hallucinations are false information that appears true. Humans producing false information may be more easily detectable based on a lack of sources and other indicators. However, when an AI model generates false information, the same indicators do not apply. For example, AI models have erroneously generated artificial reference citations to sources to support the false statements. Because of the above, when text is known to be generated by AI, human readers can be wary of possible inaccuracies. Challenges exist when humans take credit for the text generated by AI and do not acknowledge the role that AI performed in authoring the text. Thus, a problem exists in identifying whether text for which a human takes credit is actually generated by AI.

Exacerbating the problem is the rapid improvement in AI models in replicating attributes of human generated text as well as the ever expanding use of AI in writing and editing tasks, from simple proofreading to suggesting phrases.

### SUMMARY

In general, in one aspect, one or more embodiments relate to a method that includes obtaining an input document, parsing the input document into tokens, generating, by an embedding model, token embeddings for the tokens, and aggregating the token embeddings across the input document to obtain a document embedding. The method further includes performing, by a document prediction model processing the document embedding, a document level classification to obtain a set of document class probabilities including an AI generated probability, a mixed probability, and a human generated probability. The method further includes presenting the set of document class probabilities.

In general, in one aspect, one or more embodiments relate to a system that includes at least one computer processor and an AI detector executing on the at least one computer processor for performing operations. The operations include obtaining an input document, parsing the input document into tokens, generating, by an embedding model, token embeddings for the tokens, and aggregating the token embeddings across the input document to obtain a document embedding. The operations further include performing, by a document prediction model processing the document embedding, a document level classification to obtain a set of document class probabilities including an AI generated probability, a mixed probability, and a human generated probability. The operations further include presenting the set of document class probabilities.

In general, in one aspect, one or more embodiments relate to a method that includes obtaining an input document, parsing the input document into tokens, and generating, by an embedding model, token embeddings for the tokens. The method further includes aggregating the token embeddings across each of at least a subset of sentences in the input document to obtain sentence embeddings, and performing, by a sentence prediction model processing the sentence embeddings and for each of the at least the subset of sentences, a sentence level classification to obtain sets of sentence class probabilities including an AI generated probability, a mixed probability, and a human generated probability. The method further includes presenting the sets of sentence class probabilities.

Other aspects of one or more embodiments will be apparent from the following description and the appended claims.

### BRIEF DESCRIPTION OF DRAWINGS

FIG. 1 shows a diagram of a system in accordance with one or more embodiments.

FIG. 2 shows a diagram of an artificial intelligence detector in accordance with one or more embodiments.

FIG. 3 shows a diagram of an embedding model in accordance with one or more embodiments.

FIG. 4 shows a diagram of a document prediction model in accordance with one or more embodiments.

FIG. 5 shows a flowchart for training an AI detector in accordance with one or more embodiments.

FIG. 6 shows a flowchart for generating a labeled set of training documents in accordance with one or more embodiments.

FIG. 7 shows a flowchart for performing AI classification in accordance with one or more embodiments.

FIG. 8 shows a flowchart for generating a set of possible explanations in accordance with one or more embodiments.

FIG. 9 shows a flowchart for selecting an explanation in accordance with one or more embodiments.

FIG. 10 shows an example user interface in accordance with one or more embodiments of the invention.

FIG. 11A and FIG. 11B show a computing system in accordance with one or more embodiments of the invention.

Like elements in the various figures are denoted by like reference numerals for consistency.

### DETAILED DESCRIPTION

In general, embodiments are directed to detecting artificial intelligence (AI) generated texts using a deep learning architecture. AI models include any machine learning based architecture that is capable of generating text. One or more embodiments are directed to a machine learning framework that is configured to perform at least a trinary classification of an input document. The trinary classification includes whether a particular document is AI generated, human generated, or mixed. More specifically, the trinary classification includes an individual corresponding probability for each class that specifies the likelihood of the input document belonging to the class. Additionally, the classification may be performed on a per document or per sentence basis. Namely, the classification may be performed for the input document as a whole as well as for individual sentences in the input document.

To perform the classification at the different levels of granularity, one or more embodiments combine different machine learning models. An encoder machine learning model generates token embeddings that are vectors of individual tokens in the document. Then, according to the level of granularity, the tokens are aggregated to generate a corresponding embedding, such as a document embedding for the input document or a sentence embedding for the particular sentence in the input document. The corresponding embedding is processed by a corresponding prediction model that is trained to perform the trinary classification. By using corresponding models that are defined for a particular level of granularity and by aggregating for the particular level of granularity, embodiments are able to perform a more detailed classification.

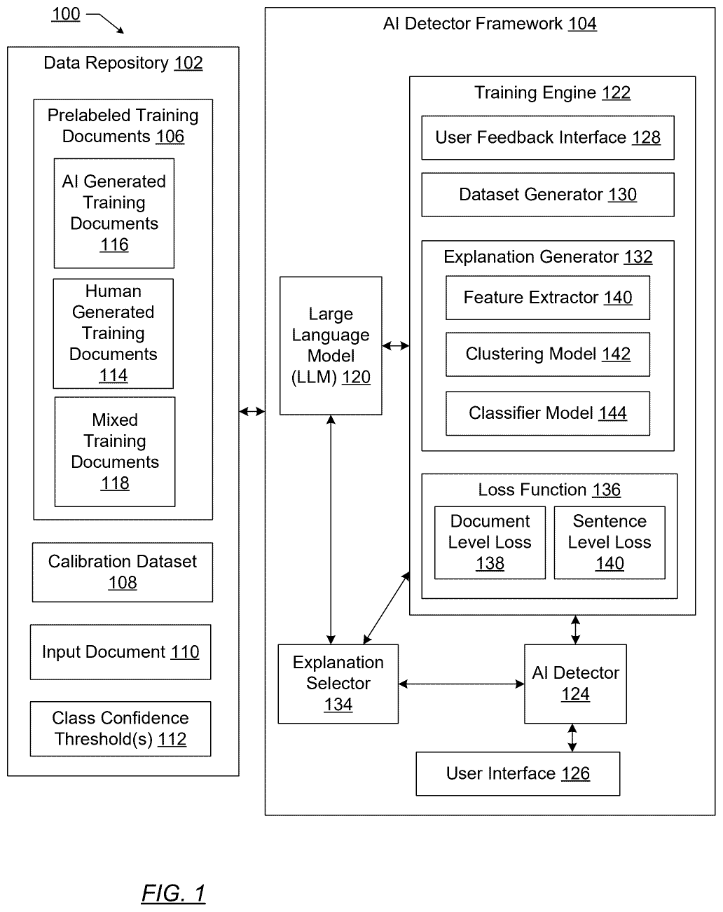

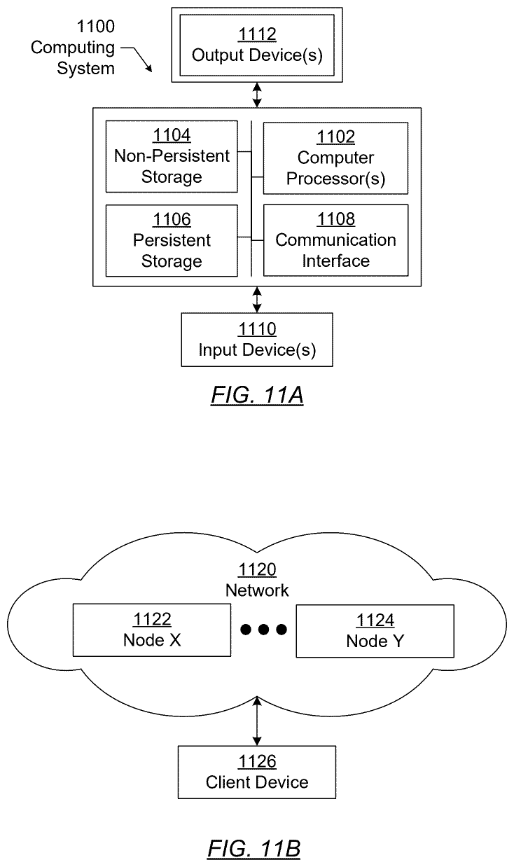

Turning to the figures, FIG. 1 shows a diagram of a system (100). The system may be implemented on the computing system shown in FIG. 11A and FIG. 11B described below. As shown in FIG. 1, the system (100) includes a data repository (102) and an AI detector framework (104). The data repository (102) is any type of storage unit and/or device (e.g., a file system, database, data structure, or any other storage mechanism) for storing data. Further, the data repository (102) may include multiple different, potentially heterogeneous, storage units and/or devices.

The data repository (102) includes functionality to store evaluation prelabeled training documents (106), a calibration dataset (108), an input document (110), and one or more class confidence thresholds (112). Each of these components is below.

A document as used herein is a discrete form of information that includes data. The data may include images and/or encoded text. For example, the images may include text that is not recognized or is to be processed by an optical character recognition engine in order to recognize the text. The document may be structured or unstructured. Additionally, the document may include tables, pictures and other images, graphs, form elements, and other features. A document may be stored in a file and may be the entire file or a portion of the file. For example, the document may be a section of the file. The document includes text that is partitioned into tokens. A token is an individual term, such as a word or abbreviation, in the document. In other words, a token is the smallest indivisible unit of the document that has a meaning.

The prelabeled training documents (106) are documents that have known labels for the documents that are usable to train the AI detector (124) described below. Each document in the prelabeled training documents (106) has at least one label defining the class of the document. The prelabeled training documents (106) may also have a class associated with individual portions of the document, such as individual sentences in the document. The prelabeled training documents (106) include human generated training documents (114), AI generated training documents (116), and mixed training documents (118). Human generated training documents (114) are training documents that are associated with a human generated class label. Human generated training documents (114) are documents that are entirely authored by a human. For example, human generated training documents (114) may be documents that predate the creation or general use of generative AI. Thus, human generated training documents (114) are virtually guaranteed of being created by a person.

AI generated training documents (116) are training documents prelabeled with an AI generated label. Specifically, AI generated training documents (116) are training document in which one or more AI models are instructed to generate. An AI generated training document may be entirely written by an AI model. As another example, an AI generated training document may be a paraphrased version of a human generated training document. An AI model is deemed to write a document when the AI model receives or detects a topic and writes the document without using the phrasing in the document. The AI model is deemed to paraphrase a document when the AI uses the original phrasing in the document as input and produces a summary or other paraphrasing as output. Thus, AI generated training documents may be associated with a first label indicative that the document is AI generated and a second label indicative of whether the document is entirely AI generated or a paraphrased document.

Mixed training documents (118) are training documents prelabeled with an AI generated label. The mixed training documents (118) are documents that have a combination of AI generated text and human generated text. For example, mixed training documents may have one or more paragraphs or sections that are written or revised by an AI model. A mixed training document may have portions entirely written by an AI model. As another example, mixed training document may be a revised version of a human generated training document. An AI model is deemed to write a paragraph or section when the AI model receives or detects a topic and writes a paragraph or section without using the phrasing in the document. The AI model is deemed to revise a section when the AI uses the original phrasing in the document as input and produces modified phrasing as output. Thus, mixed training documents may be associated with a first label indicative that the document is a mixed document and a second label indicative of some paragraphs or sections being revised by AI or written by AI.

The prelabeled training documents (106) may span several domains. As such the document prediction model and the sentence prediction model may be a generically trained model because of being trained across the multiple domains. A domain is an area of knowledge or a grouping of document types (e.g., academic papers, web pages, patent applications, user manuals, etc.). A calibration dataset (108) is a set of prelabeled training documents that are defined for a particular domain. For example, a calibration dataset may include human generated training documents, mixed training documents, and AI generated training documents, as described above, but for the particular domain. Because the calibration dataset (108) is related to a particular domain, the calibration dataset (108) is a domain specific calibration dataset that is much smaller than the prelabeled training documents (106).

The input document (110) is the document on which classification is performed. Namely, the input document (110) does not have a known class to the user that provides the new document. The input document (110) may be a document for a particular domain.

Class confidence thresholds (112) are thresholds on the probabilities that distinguishes between whether the documents are detected as belonging to a class and whether the document is detected as not belonging to the class. Each class has a corresponding class confidence threshold.

Continuing with FIG. 1, the AI detector framework (104) is a set of computer instructions that cause the computer system to detect a level of AI used to generate an input document. The AI detector framework (104) may include or be connected to a large language model (LLM) (120), a training engine (122), an AI detector (124), an explanation selector (134) and a user interface (126). The LLM (120) is a type of machine learning model that is capable of processing, understanding, and generating natural language. The term, LLM, corresponds to the standard definition.

A user interface (126) is an interface configured to interact with a user. For example, the user interface (126) is configured to receive an input document from the user and output the AI classification of the input document. The user interface includes one or more widgets for presenting the output.

The AI detector (124) is a machine learning system that is configured to detect the AI classification of input document. For example, the AI detector may include one or more machine learning models for detecting the classification on the document and sentence level. Further, the AI detector (124) may be configured to detect between human generated, AI generated, and mixed. Further, the output of the AI detector may be a per sentence, paragraph, or per document basis.

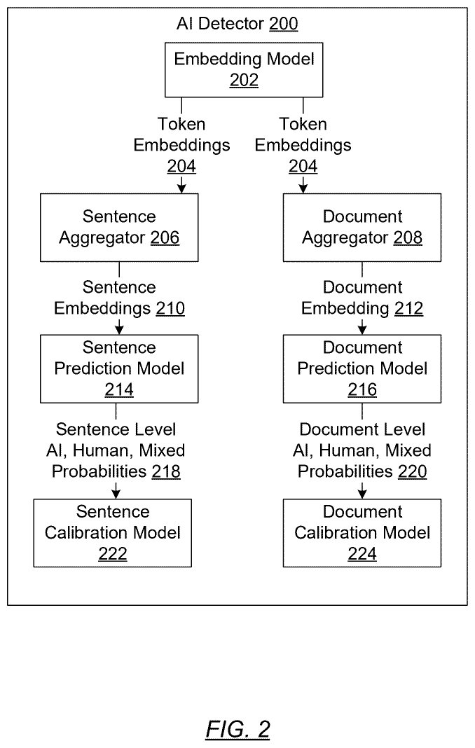

The AI detector (124) may include neural networks and may operate using one or more layers of weights that may be sequentially applied to sets of input data (e.g., training dataset, evaluation dataset, new document), which may be referred to as input vectors. For each layer of a machine learning model, the weights of the layer may be multiplied by the input vector to generate a collection of products, which may then be summed to generate an output for the layer that may be fed, as input data, to a next layer within the machine learning model. The output of the machine learning model may be the output generated from the last layer within the machine learning model. Multiple machine learning models may operate sequentially or in parallel. The output may be a vector or scalar value. The layers within the machine learning model may be different and correspond to different types of models. As an example, the layers may include layers for recurrent neural networks, convolutional neural networks, transformer models, attention layers, perceptron models, etc. Perceptron models may include one or more fully connected (also referred to as linear) layers that may convert between the different dimensions used by the inputs and the outputs of a model. Different types of machine learning algorithms may be used, including regression, decision trees, random forests, support vector machines, clustering, classifiers, principal component analysis, gradient boosting, etc. The AI detector (124) in accordance with some embodiments is described in FIG. 2.

Continuing with FIG. 1, the training engine (122) is configured to train the AI detector (124). The training engine (122) includes a user feedback interface (128), which may or may not be a part of user interface (126). The training engine (122) also includes a dataset generator (130). The dataset generator (130) configured to acquire training documents from one or more public and private repositories, and generate additional training documents from the acquired documents, and modify portions of the acquired and generated training documents. The training engine (122) may further cluster the training documents according to domain and manage the training of the AI detector (124).

The training engine (122) includes a loss function (136). The loss function is configured to calculate a loss based on the prediction using the training documents. The loss function (136) calculates a combination of document level loss (138) and sentence level loss (140). Document level loss (138) is the loss at the document level and calculated from the class label of the document as compared to the predicted class of the document. Sentence level loss (140) is the loss calculated from the class labels of individual sentences and reflects the difference between the predicted class and the prelabeled class.

More specifically, the AI detector (124) may be trained by inputting training data to a machine learning model to generate training outputs that are compared to expected outputs (i.e., prelabeled class versus predicted class). The difference between the training output and the expected output may be processed with the loss function (136) to identify updates to the weights of the layers of the model. After training on a batch of inputs, the updates identified by the loss function may be applied to the machine learning model to generate a trained machine learning model. Different algorithms may be used to calculate and apply the updates to the machine learning model, including back propagation, gradient descent, etc.

In one or more embodiments, the training engine (122) includes an explanation generator (132). The explanation generator (132) includes functionality to generate a set of possible explanations for the identification of a set of AI features from the AI generated training documents (116) and a set of human features from human generated training documents (114). The explanation generator (132) includes a feature extractor (140), a clustering model (142), and a classifier model (144). The feature extractor is configured to extract features from the training documents. The clustering model is a machine learning model that is configured to cluster the features into clusters. For example, the clustering model may be a community detection algorithm or a k-means clustering algorithm. The classifier model (144) is a machine learning model configured to classify the training documents into human generated or AI generated and output the prominence of each feature in the training. For example, the classifier model may be a transformer model. The explanation generator (132) is further configured to generate an explanation for each corresponding feature.

The explanation selector (134) is a set of instructions for selecting an explanation corresponding to a document. For example, the explanation selector may operate with the LLM (120) to select an explanation from a set of possible explanations. In some embodiments, the explanation selector (134) selects an explanation for each sentence in the input document (110).

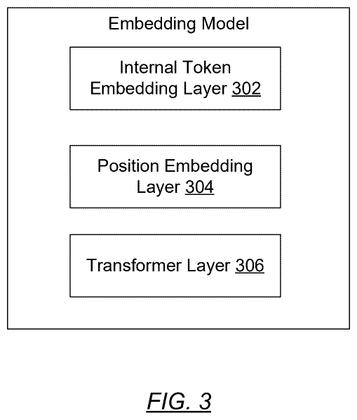

FIG. 2 shows an example of an AI detector (200) in accordance with one or more embodiments. The AI detector (200) in FIG. 2 is an example of the AI detector (124) in FIG. 1. Turning to FIG. 2, the AI detector (200) includes an embedding model (202) configured to generate token embeddings (204) from tokens of the document. An embedding is a vector representation of the underlying data (e.g., token, sentence, document, etc.). An embedding represents the underlying data numerically. The embedding encodes the semantic meaning of the underlying data with respect to the functionality of the AI detector. In one or more embodiments, the embedding model is a Roberta Model. For example, the embedding model (202) may be the embedding model (300) shown in FIG. 3. Turning briefly to FIG. 3, the embedding model (300) includes an internal token embedding layer (302) that converts the token into a semantic representation of the token. The position embedding layer (304) encodes the position of the token. The internal embedding and the position embedding are combined to create a combined embedding. For example, the combination may be summation or concatenation. The combined embedding is passed through a transformer layer (306). The transformer layer is a small neural network that combines the position and internal encodings. For example, the transformer layer may include various attention layers that modify the token embedding to create an output token embedding.

Returning to FIG. 2, the token embeddings (204) are passed through a sentence aggregator (206) and a document aggregator (208). The sentence aggregator (206) is configured to aggregate the token embeddings of the tokens of a sentence to generate sentence embeddings (210). Each sentence may have an individual corresponding sentence embedding that is formed by the tokens of the sentence. For example, the aggregation may be to average the tokens. The document aggregator (208) is configured to aggregate the tokens across the document to form a document embedding (212). For example, the aggregation may be to average the tokens.

The sentence prediction model (214) is configured to take, as input, the sentence embeddings (210) and produce, as output, sets of sentence class probabilities. The sentence prediction model (214) may be a multilayer perceptron model or other neural network model that operates on a per sentence embedding basis. The set of sentence class probabilities are the probabilities that a particular sentence belongs in a particular AI class. In one or more embodiments, the set of sentence class probabilities includes sentence level AI generated probability, mixed probability, and human generated probability (218).

The document prediction model (216) is configured to take, as input, the document embedding (212) and produce, as output, a set of document class probabilities. The document prediction model (216) may be a multilayer perceptron model or other neural network model that operates on the overall document basis. The set of document class probabilities are the probabilities that a particular document belongs in a particular AI class. In one or more embodiments, the set of document class probabilities includes sentence level AI generated probability, mixed probability, and human generated probability (220).

The sentence calibration model (222) and the document calibration model (224) are neural network models that are configured to calibrate the probabilities to generate an output set of probabilities. The calibration may be performed to accommodate the different domains. Specifically, the set of prelabeled training documents may be in a different domain or domains than the input document. Because of the difference, the probabilities generated by the corresponding prediction model may not represent the real probability. To accommodate the difference, a corresponding calibration model, trained for the specific domain is designed to transform the set of probabilities to generate a set of output probabilities.

The set of document class probabilities and the sets of sentence class probabilities, and, thus, the output probabilities, include a probability for each class. Thus, for example, an input document having 75% probability of being human generated means that there is a 75% likelihood of the AI detector being correct that the document is human generated rather than 75% of the document is human generated. Similarly, a sentence having a 60% mixed probability means that the sentence prediction model has a 60% likelihood of being correct that the sentence is AI generated rather than 60% of the sentence being AI generated.

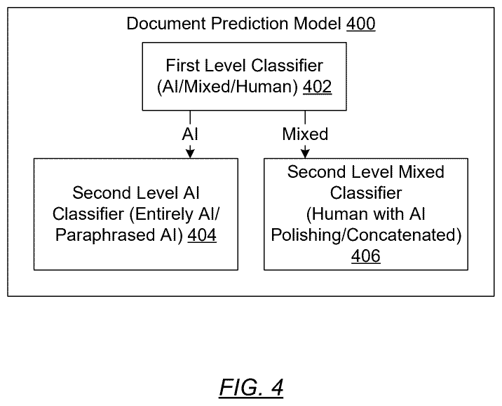

Further, the probabilities may be performed on multiple levels of classification. For example, an AI generated document may be a document that is summarized by AI or a document that is written by AI. Similarly, a mixed class may be mixed because an AI model generated some of the sections or because the AI model edited some of the sections. Thus, each classification level may have a corresponding probability. FIG. 4 shows an example of a document prediction model (400) that can perform the classification across the different levels. The document prediction model (400) in FIG. 4 is an example of the document prediction model (216) in FIG. 2.

As shown in FIG. 4, the document prediction model (400) may be a combination of three classifier models that are on different levels. The first level classifier (402) model is configured to generate a set of document prediction probabilities for AI generated, mixed, or human generated. A comparator (not shown) may be configured to generate a comparison result between the respective probability and the corresponding threshold. On the second level, a second level AI classifier (404) is configured to determine the probability that the document is entirely AI generated or paraphrased by AI. Also, on the second level, a second level mixed classifier (406) is configured to determine the probability that the document is human with AI polishing the document (i.e., revised by AI) or only has sections generated by AI (i.e., human generated, concatenated with AI generated). Each of the classifiers shown in FIG. 4 may be an individual multilayer perceptron model. Other types of classifiers may be used.

While FIGS. 1-4 shows configurations of components, other configurations may be used without departing from the scope of the invention. For example, various components may be combined to create a single component. As another example, the functionality performed by a single component may be performed by two or more components.

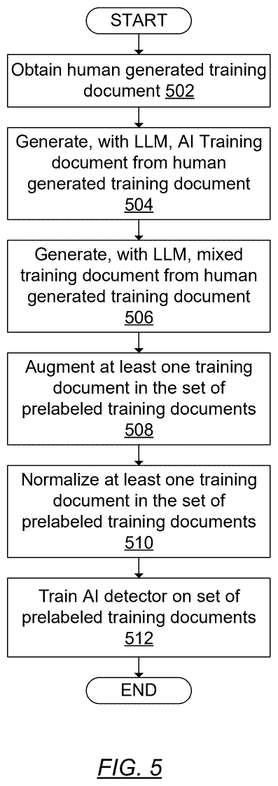

FIG. 5-7 show flowcharts in accordance with one or more embodiments. The operations of the flowcharts may be performed using the system described above and shown in FIGS. 1-4. While the various steps in these flowcharts are presented and described sequentially, at least some of the steps may be executed in different orders, may be combined or omitted, and at least some of the steps may be executed in parallel. Furthermore, the steps may be performed actively or passively.

FIG. 5 shows a flowchart for training an AI detector in accordance with one or more embodiments. Block 502 includes obtaining a human generated training document. Training documents may be obtained from public and private data sources, such as by accessing one or more servers via a network. Human generated training documents may be obtained based on the dates of last edit in the training documents. For example, any training document that predates the use of AI text generation technology is assumed to be human generated. Clustering may be performed on the training documents to generate clusters. Biases may be identified from the clusters. For any identified biases, further training documents may be obtained.

Moreover, at least some of the training documents may be separated into individual domains. Namely, the training documents may be assigned to each particular domain. The domains may be determined from the origin of the training documents or by sending the training documents to an LLM and prompting the LLM to respond with the domain.

The result of Block 502 is a set of human generated training documents that are assigned the human generated label.

Block 504 includes generating, with an LLM, an AI training document from the human generated training document. In one or more embodiments, the LLM is prompted to generate an AI training document from the human generated training document. The AI training document may be received from the LLM and assigned the AI generated label. For example, to generate an AI generated training document, an LLM may be prompted to identify a topic of the human generated training document. The prompt may further include a request to identify the structure of the document. The result may be passed in a prompt to an AI model, which may be the same or a different LLM, which is then prompted to generate a document according to the topic and the structure. The result is an AI generated document that is added to the prelabeled training documents. Further, the AI model may be prompted to paraphrase the human generated document. The result is an additional AI generated document with a corresponding paraphrase label.

The dataset generator may send the same prompt to multiple AI models to obtain a variety of AI generated training documents that reflect how the various AI models generate text. Each AI model may individually process the prompt to generate corresponding training documents. By using multiple AI models for training, the AI detector is trained to perform the classification across a wide range of AI models.

The different types of AI generated documents are added to the prelabeled training documents. The labels may be on multiple class levels.

Block 506 includes generating, with an LLM, a mixed training document form the human generated training document. Generating the mixed training document may be performed similar to generating the AI generated training document from the AI model. Specifically, a human generated training document is selected. The LLM is prompted to generate a set of mixed training documents from the human generated training document. For example, an LLM may be prompted to identify the topic of a portion (e.g., paragraph, section, or other portion) of the human generated training document. Then, the AI model may be prompted to generate a new portion to replace the existing portion. Thus, the set of mixed training documents may each involve replacing one or more portions of the human generated training document with an AI rewritten portion or the new portion. As another example, one or more AI models may be prompted to replace one or more portions with a revised portion. For example, the prompting may be to rephrase a particular portion.

Blocks 504 and 506 may be performed algorithmically by the dataset generator. For example, the dataset generator may request information about each human generated document from the LLM. Then, the dataset generator may populate prompt templates based on the result to generate multiple prompts. Prompts may be transmitted to the AI models to generate multiple AI generated documents and mixed documents from a single human generated document. The results may be labeled according to the prompt and stored in the prelabeled training dataset.

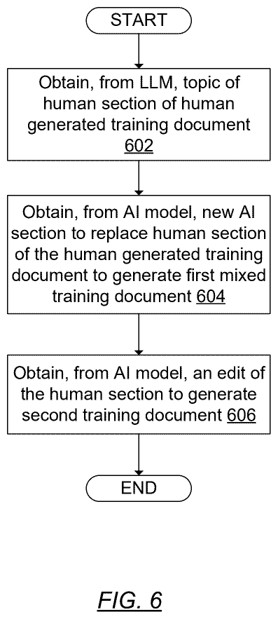

Blocks 504 and 506 are shown in FIG. 6.

Block 508 includes augmenting at least one training document in the set of prelabeled training documents. One or more of the training documents may be augmented by introducing mistakes, such as spelling mistakes or grammatical errors. The augmentation does not change the label of the training document. The augmentation reflects that AI models may be prompted to try and replicate human generation, including the addition of mistakes.

Block 510 includes normalizing at least one training document in the set of prelabeled training documents. Normalizing the at least one training document removes the presence of artifacts that uniquely identify a training document as human generated, or AI generated. Examples of such artifacts may be the dates on the human generated or AI generated documents, the identification of a particular AI model, the identification of AI generally. Thus, an AI generation artifact may be removed as part of the normalization.

Block 512 includes training the AI detector on the set of prelabeled training documents. Training the AI detector includes generating a loss from classifying a set of prelabeled training documents including the AI generated training documents, human generated training documents, and mixed training documents. Further, the loss is backpropagated through the sentence prediction model, the document prediction model, and the embedding model. More specifically, training the AI detector includes updating layers and weights in the layers of the AI detector based on a calculated loss from the training, including updating the weights of the document prediction model and the sentence prediction model are trained. The respective document prediction model and sentence prediction model may be co-trained or may be separately trained. The training generates a set of predicted probabilities for the document overall and for individual sentences in the document. For the individual sentences, the predefined labels are determined from the labels of the document in the case of the AI and human generated training documents. Further, the predefined labels of individual sentences for mixed training documents are based on whether the section is replaced by the AI model. The predefined labels for the individual sentences are used to calculate the loss. The predicted probabilities for the document are compared against the actual labels to calculate a document level loss. Similarly, the predicted probabilities for the sentences are compared against the actual labels of the individual sentences to calculate a sentence level loss. The document level and sentence level losses are combined to generate a total loss. The total loss is then backpropagated through the entire AI detector, including the embedding model.

In addition to training the AI detector, the calibration model for the particular domain is also trained. The calibration model is trained by using the training documents only in the domain (i.e., domain specific calibration set). For example, the calibration model may be a regression model. The regression model may be trained to minimize an expected calibration error. The domain specific calibration set is smaller than a generic training set that trains the document prediction model and the sentence prediction model.

The AI detector may be evaluated with a set of evaluation documents. Evaluating the AI detector includes comparing the predicted output of the AI detector to the expected output. If the AI detector fails to satisfy an accuracy threshold, further training may be performed.

FIG. 6 shows a flowchart for generating a labeled set of training documents in accordance with one or more embodiments. Block 602 includes obtaining, from an LLM, a topic of a human section of a human generated training document. The LLM is prompted to identify the topic of the human section and information about the human section, such as length. Determining the human section for prompting may be performed based on section labels. Block 604 includes obtaining, from an AI model, a new AI section to replace the human section of the human generated training document to generate a first mixed training document. The AI model is prompted with the topic and the section information to generate section.

Block 606 includes obtaining, from an AI model, an edit of the human section to generate a second training document. The AI model is prompted with the topic and the section information to revise section.

The result of Block 604 and Block 606 is a mixed training document that is added to the prelabeled training documents.

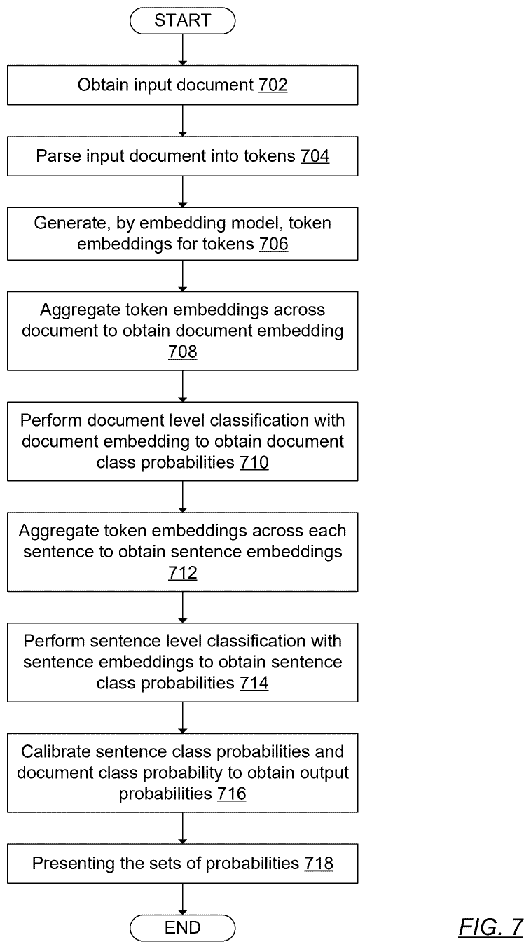

FIG. 7 shows a flowchart for performing AI classification in accordance in accordance with one or more embodiments. Specifically, the processing performed in FIG. 7 is performed when the AI detector is deployed. Block 702 includes obtaining an input document. For example, the input document may be received via the user interface or an application programming interface. The user may submit one or more files having the documents or may copy the text of the document into a user interface.

Block 704 includes parsing the input document into tokens. The tokens may correspond to individual words in the document. Parsing the document into tokens may be performed based on whitespace, formatting, and punctuation marks. In one or more embodiments, tokens corresponding to sentences are identified.

Block 706 includes generating, by an embedding model, token embeddings of the tokens. The token embeddings are generated by, for each token, performing the following operations. The internal token embedding layer of the embedding model generates an internal token embedding using the value of the token (i.e., the word). Further, in one or more embodiments, a position embedding layer of the embedding model generates a position embedding for a token. The corresponding position embedding is combined with the token embedding to form a combined embedding and passed through a transformer model. For example, the combination may be to sum the position embedding with the token embedding. Other combinations may be used without departing from the scope of the claims. The transformer model may apply one or more self-attention layers to generate an output token embedding for the token.

Block 708 includes aggregating the token embeddings across the document to obtain document embeddings. The token embeddings of the document are aggregated together. For example, the aggregation may be to take an average of the token embeddings. Other aggregations may be used without departing from the scope of the claims.

Block 710 includes performing document level classification with the document embedding to obtain document class probabilities. The document embedding is processed through the document prediction model to generate the set of document level probabilities. In some cases, a two level processing is performed. For example, Block 710 may include performing a first level AI classification to obtain the AI generated probability, the mixed probability, and the human generated probability for the document. The respective probabilities may be compared against the corresponding thresholds. The comparison may be performed after the calibration model executes or before depending on the overall configuration of the system. If the document is detected as being human generated, then further processing is not performed.

Block 710 may include performing a second level AI classification by a second level AI classifier when the AI generated probability is greater than a threshold. The second level AI classification classifies the document between an entirely AI class and a paraphrased AI class. Further, Block 710 includes performing a second level mixed classification by a second level mixed classifier when the mixed probability is greater than a threshold, wherein the second level mixed classification classifies the document between human with an AI polishing class and a paraphrased AI class. If the second level classification is performed, then the set of document class probabilities include the results of the second level classification.

Block 712 includes aggregating the token embeddings across each sentence to obtain sentence embeddings. The aggregating is performed for each sentence of at least a subset of sentences. For example, the full set of sentences in the document or only a subset of sentences in the document may be processed. Each sentence is individually processed. Namely, the token embeddings for a single individual sentence are aggregated together to form a sentence embedding. The process is repeated for each sentence to obtain a corresponding sentence embedding for each sentence.

Block 714 includes performing sentence level classification with the sentence embeddings to obtain sentence class probabilities. The sentence embeddings are individually processed through the sentence embedding models to generate a set of sentence class probabilities including mixed probability, human generated probability, and AI generated probability.

Block 716 includes calibrating the sentence class probabilities and the document class probabilities to obtain output probabilities. Block 716 includes calibrating the set of document class probabilities for a particular domain to obtain a set of output probabilities. The domain of the document is determined, such as through prompting the LLM and receiving the domain. Further, the calibration model for the particular domain is selected. The calibration model processes the sets of probabilities to generate the output probabilities.

Block 718 includes presenting the sets of probabilities. In some cases, the set of document class probabilities are displayed. The presentation may be storing or displaying in the user interface the probabilities, the calibrated or output probabilities, or the class after comparison with the corresponding thresholds. The presenting of the sentence class probabilities may be performed by tagging sentences or document sections that are identified as being AI generated or mixed generated. Different techniques may be performed to present the probabilities including displaying the probabilities or the classes. Each of the different techniques are contemplated herein.

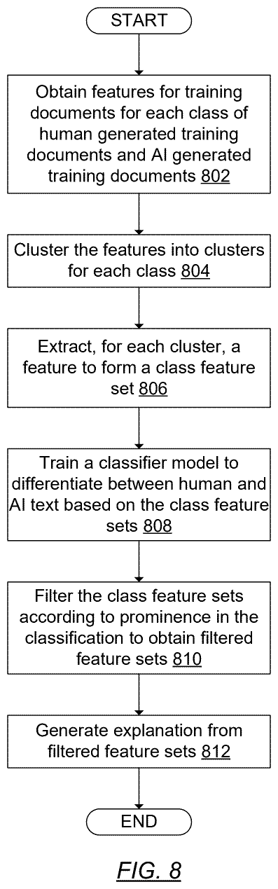

FIG. 8 shows a flowchart for generating a set of possible explanations in accordance with one or more embodiments. The flowchart of FIG. 8 may be performed to transform a large set of features into a smaller set of features that are indicative of whether a document is AI generated or human generated. For example, hundreds or thousands of features may be transformed to explanations of thirty or fifty features. Block 802 includes obtaining features for training documents for each class of human generated training documents and AI generated training documents. Features are obtained for pairs of human generated training documents and corresponding AI generated training documents (i.e., that is generated from the human generated training document). To obtain the feature, the LLM is prompted with the PAIR and requested to identify the feature that makes the pair different. The feature is then labeled with AI generated feature label or human generated feature label based on whether the feature is exhibited in the AI generated training document or the human generated training document in the PAIR. Human generated features may be obtained by asking the LLM what makes the human generated training document different from the corresponding AI generated training document in the pair. AI generated features may be obtained by asking the LLM what makes the AI generated training document different from the corresponding human generated training document in the pair. The result are thousands of features in text format that are associated with human generated or AI generated. Namely, the human generated features are the features that are output by the LLM from human generated training documents while the AI generated features are features that are output by the LLM from AI generated training documents.

Block 804 includes clustering the features into clusters for each class of human generated or AI generated. Block 804 is performed independently for the human generated features as for the AI generated features to generate two cluster sets (i.e., an individual set of clusters for human generated features and an individual set of clusters for AI generated features). In one or more embodiments, to cluster the features, the features are transformed into vector embeddings. The vector embedding of the feature retains the association with the text format of the feature. To generate the vector embedding, an embedding model is used. For example, the same or a different version of the embedding model of FIG. 3 may be used to generate a vector embeddings of the features. As another example, a general sentence transformer model may be used on each text format of the feature to generate the vector embeddings. The vector embeddings are clustered. Clustering the vector embeddings may be performed with a community detection algorithm, a k-means clustering algorithm, or other clustering algorithm.

Block 806 includes extracting, for each cluster, a feature to form a class feature set. In one or more embodiments, the following operations is performed for each cluster. A set of text formats of features corresponding to vector embeddings in the cluster is added to a prompt template for an LLM to create a prompt. The prompt template, and, thereby the prompt, requests that the LLM create a natural language text that represents the cluster of the set of features in text format. For example, the prompt may request that the LLM summarize of the cluster or otherwise create an amalgamation of the features in text format based on the set of features of the cluster. In some embodiments, the distance of each vector embedding to the centroid is used to add a weight, in the prompt, the corresponding feature in text format. The prompt is transmitted to the LLM, which processes the prompt by applying various layers of the LLM to create a text feature. As another example to create a text feature for the cluster, a centroid of each cluster, or a vector embedding closest to the centroid is selected as a representative vector embedding for the cluster. The text format of the representative vector embedding may be used as the representative feature in text form for the cluster.

A result of performing the processing of Block 806 is a representative feature in text format for each cluster of the set of clusters, whereby the representative feature is associated with an AI generated label or a human generated label. The feature sets may be referred to as class feature sets (e.g., human generated feature set, AI generated feature set).

Block 808 includes training a classifier model to differentiate between human and AI text based on the class feature sets to obtain a classification. The set of human generated training documents and the set of AI generated training documents is used to train the classifier with just the class feature sets. Remaining features from Block 802 may be ignored. Specifically, the features of the class feature sets are extracted from the human generated documents and the AI generated documents. Notably, for at least some of the human generated documents, features in the AI generated feature set may be extracted. Similarly, for at least some of the AI generated documents, features in the human generated feature set may be extracted. The classifier model is trained by comparing the predicted output of the classifier model with the actual label associated with the corresponding document. The results are backpropagated through the classifier model to generate weights for the features. The weights identify the relative prominence of each feature in indicating whether human generated or AI generated. Thus, a byproduct of training the classifier model is a weight for each feature that is indicative of the prominence of the feature.

Block 810 includes filtering the class feature sets according to the prominence in the classification to obtain filtered feature sets. Each class feature set is individually filtered based on a threshold. For example, the threshold may be a number of features in the filtered class feature set or a filtering on the corresponding weight of the feature in the filtered class feature set. For example, the top thirty features may be used from each filtered class feature set. As another example, the top threshold percentage of features according to weight may be used. In the processing in Block 810, each feature retains its relation to the corresponding class. Thus, the processing of Block 810 generates a filtered class feature set (e.g., filtered human generated feature set, filtered AI generated feature set).

Block 812 includes generating an explanation for features in the filtered feature sets. The LLM may be prompted with each feature in the respective feature set to generate a natural language explanation of the feature. Block 812 may be an optional step that refines the explanation of Block 806. By generating filtered feature sets with corresponding natural language explanations for each feature, the processing of FIG. 8 generates a likely set of options as to why a document or individual sentence may be of a particular class.

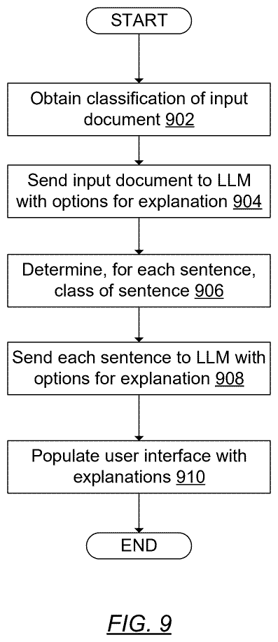

FIG. 9 shows a flowchart for selecting an explanation in accordance with one or more embodiments. Block 902 includes obtaining a class of an input document. Obtaining the class of the input document may be performed as described above with reference to FIG. 7. The AI detector transmits the class of the input document to the explanation selector.

Block 904 includes sending an input document to the LLM with options for the explanation. The explanation selector may generate an LLM prompt to the LLM that includes the document and the set of options corresponding to the class. The set of options is the filtered class feature set for the particular class. For example, the LLM prompt may include a request that the LLM identify and rank which of the features in natural language format is a reason for the document to be classified in the corresponding class. The LLM may respond with one or more of the natural language explanations ranked in a particular order.

Block 906 includes determining, for each sentence, the class of the sentence. The class of the sentence is determined using the processing of FIG. 7. The AI detector transmits the class of the sentence to the explanation selector.

Block 908 includes sending each sentence to the LLM with the options for the explanation. Each sentence may be transmitted to the LLM requesting an explanation for why the sentence may be classified as AI generated or human generated. Block 908 may be performed similar to Block 904, but on the sentence level.

In some embodiments, Block 908 is performed iteratively for each sentence as follows. The sentence is removed from the document and a determination is made whether the document retains the class. If the document does not retain the class, then a prompt is transmitted to the LLM with the options for the class of the document requesting an explanation as to why the particular sentence is indicative of the document being classified in the corresponding class. The LLM responds with the explanation, which the explanation selector relates to the sentence. The processing of Block may be repeated for each sentence.

Block 910 includes populating the user interface with the explanations. The user interface may include the document, the class of the document, and the natural language explanation for why the document was classified in the class. Further, each sentence or certain sentences may be highlighted with explanations indicating why the sentence is associated with the particular class. The result is a display in an easy to read format presenting the sentence.

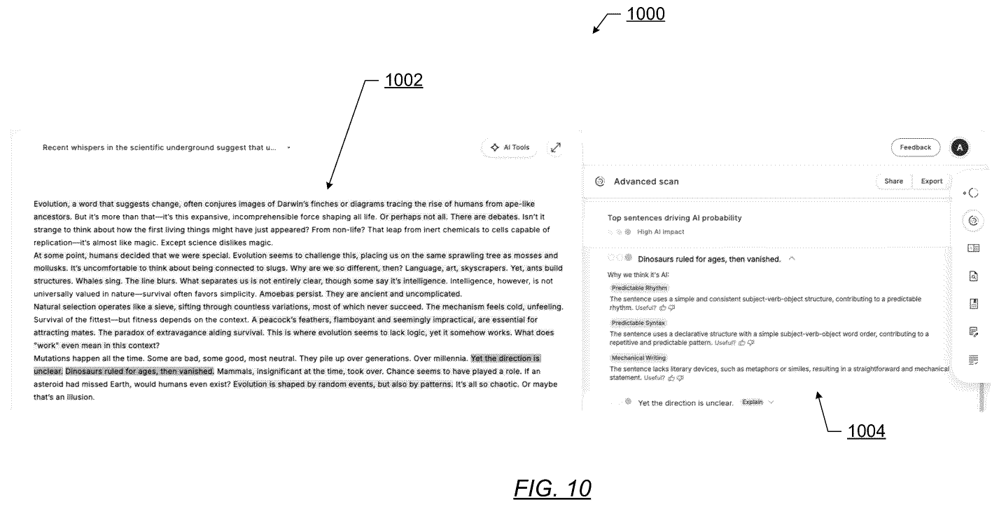

FIG. 10 shows an example user interface (1000) in accordance with one or more embodiments. In the example, the document is classified as AI with a higher than a threshold AI probability. The left pane (1002) of FIG. 10 shows selected sentences highlighted based on the sentences driving the AI classification. The right pane (1004) of the user interface shows natural language explanations of why the document is classified using the AI generated probability. For example, the natural language explanations include a sentence form explanation of predicable rhythm, predicable syntax, and mechanical writing. The user may use the explanation to transform the document to a more human generated text.

The example may be performed for multiple uses. For example, the drafter may use embodiments to determine which parts of the documents they wrote were most unique to them, and which sound most like they were AI generated. As another example, a third party may use embodiments to determine the class of the document and the degree to which AI is used, even at sentence level.

Below is a more detailed description of an implementation. Embodiments may deviate from the implementation below without departing from the scope of the claims. One or more embodiments uses a deep learning architecture, and, as such, performance is proportional to the scale and diversity of the data on which the AI detector is trained. The data gathering pipeline may involve regularly collecting publicly available datasets with commercial-friendly licenses of both human-written and AI written text. The data gathering pipeline additionally uses a proprietary generation pipeline using various prompting strategies to generate texts from popular LLM providers, such as OpenAI LLM, Anthropic models, GOOGLE® models, and open-source LLMs.

Given that the AI detector is data-driven, the learning biases in the data help distinguish human and AI text, such as text formatting. One or more embodiments employ both statistical methods and manual inspection datasets to uncover and address issues. To help focus our data gathering and generation efforts, one or more embodiments implement a user feedback mechanism where users can dispute predictions that the user believes is incorrect. Clustering documents with such feedback, the identification of the most relevant and underrepresented domains identify common failure cases, which one or more embodiments use to scope our future data collection and training efforts. Namely, the clustering model clusters the document using the attributes of the document and the positive or negative feedback from the document. The attributes may or may not be the same as the token embeddings. If a particular cluster has more than a threshold percentage of negative feedback, then the documents having the similar attributes as the particular cluster are selected for further training of the AI detector.

Moreover, one or more embodiments evaluate one or more embodiments on historical user submissions and track the evolution of the detector's predictions with newer model versions.

The AI detector uses a deep learning architecture trained in a supervised fashion. The AI generated text detection is a trinary classification problem consisting of human, AI, and mixed classes. A document is said to be mixed if less than 90% of the text is human-written and less than 90% of the text is AI generated, regardless of the order of the human-written and AI generated segments. An example of such a mixed document is one that contains human-written instructions interleaved with AI generated responses. In a binary setting lacking the mixed class, a detector would be forced to choose between a human or AI classification presenting false dichotomy to its user. Moreover, the score assigned by a binary classifier lacks interpretability. For instance, a 50% AI generated score could either mean the detector is 100% confident that 50% of the text is AI generated, or that the detector is 50% confident that the document is entirely AI generated. The use of the mixed class allows us to decouple model confidence and the proportion of the text generated by an AI.

By representing a document as a sequence of n sentences d=(s₁, . . . , sₙ), one or more embodiments enable fine-grain predictions for mixed documents. In particular, one or more embodiments produces both document level predictions, f_{doc}(d)=(p_{Human}, p_{AI}, p_{Mixed}), as well as predictions for each sentence individually,

$${f}_{sent} ( d ) = ( {p}_{AI}^{( 1 )} , ... , {p}_{AI}^{( n )} ) .$$

To enable these sentence level predictions, one or more embodiments adopt a multi-task loss L=L_{d}+αLₛ where L_{d} is the document level cross-entropy loss, Lₛ is the sentence level binary cross-entropy loss, and α is a hyperparameter trading-off the two. One or more embodiments frame sentence level predictions as a binary classification problem due to lack of a well-defined criteria for what mixed or polished sentences are. By training the AI detector with this multi-task objective, one or more embodiments efficiently produces both document and sentence level predictions in a single forward pass. These predictions provide significantly finer-grain and more explainable detections over competing detectors that have no principled way of representing mixed documents.

During training, one or more embodiments form documents by randomly sampling a sequence of consecutive sentences, such that the document fits within our model's context length, T. In particular, a training document Sample(d, T)=(sᵢ, sᵢ₊₁, . . . , sⱼ) will satisfy 1≤i≤j≤n and

$${\sum }_{k = i}^{j} \vert {S}_{k} \leq T .$$

This construction avoids long documents disproportionately affecting training compared to shorter documents while also simplifying the construction of mixed documents by sampling human-written and AI written sentences from the same topic.

To ensure one or more embodiments' robustness and consistency, one or more embodiments apply cleaning and reformatting to the document before inference, such as removing extraneous whitespace. If a document, d, does not fit in the detector's context length, one or more embodiments split it into disjoint windows W₁, . . . , Wₘ such that d=concat(W₁, . . . , Wₘ) and |Wᵢ|≤T for i=1, . . . , m. One or more embodiments recover a document level prediction by f_{doc}(d)=agg(f_{doc}(W₁), . . . , f_{doc}(Wₘ)) and sentence level predictions by fₛₑₙₜ(d)=concat(fₛₑₙₜ(W₁), . . . , fₛₑₙₜ(Wₘ)) for some aggregate agg (e.g., average, median, maximum).

Finally, one or more embodiments leverage a remapping function r: R³→R³ to produce our overall document level predictions r(f_{doc}(d)). This post-processing improves calibration and corrects against a bias towards producing false-positive predictions.

The user interface in some embodiments displays the predicted class and associated confidence scores, along with tooltips explaining how to interpret these values. These explanations help ensure the responsible use of the detector. Advanced users may also specify a confidence threshold appropriate for their required levels of precision and recall.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 11A, the computing system (1100) may include one or more computer processor(s) (1102), non-persistent storage device(s) (1104), persistent storage device(s) (1106), a communication interface (1108) (e.g., Bluetooth interface, infrared interface, network interface, optical interface, etc.), and numerous other elements and functionalities that implement the features and elements of the disclosure. The computer processor(s) (1102) may be an integrated circuit for processing instructions. The computer processor(s) (1102) may be one or more cores, or micro-cores, of a processor. The computer processor(s) (1102) includes one or more processors. The computer processor(s) (1102) may include a central processing unit (CPU), a graphics processing unit (GPU), a tensor processing unit (TPU), combinations thereof, etc.

The input device(s) (1110) may include a touchscreen, keyboard, mouse, microphone, touchpad, electronic pen, or any other type of input device. The input device(s) (1110) may receive inputs from a user that are responsive to data and messages presented by the output device(s) (1112). The inputs may include text input, audio input, video input, etc., which may be processed and transmitted by the computing system (1100) in accordance with one or more embodiments. The communication interface (1108) may include an integrated circuit for connecting the computing system (1100) to a network (not shown) (e.g., a local area network (LAN), a wide area network (WAN) such as the Internet, mobile network, or any other type of network) or to another device, such as another computing device, and combinations thereof.

Further, the output device(s) (1112) may include a display device, a printer, external storage, or any other output device. One or more of the output device(s) (1112) may be the same or different from the input device(s) (1110). The input device(s) (1110) and output device(s) (1112) may be locally or remotely connected to the computer processor(s) (1102). Many different types of computing systems exist, and the aforementioned input device(s) (1110) and output device(s) (1112) may take other forms. The output device(s) (1112) may display data and messages that are transmitted and received by the computing system (1100). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (1102), is configured to perform one or more embodiments, which may include transmitting, receiving, presenting, and displaying data and messages described in the other figures of the disclosure.

The computing system (1100) in FIG. 11A may be connected to, or be a part of, a network. For example, as shown in FIG. 11B, the network (1120) may include multiple nodes (e.g., node X (1122) and node Y (1124), as well as extant intervening nodes between node X (1122) and node Y (1124)). Each node may correspond to a computing system, such as the computing system shown in FIG. 11A, or a group of nodes combined may correspond to the computing system shown in FIG. 11A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (1100) may be located at a remote location and connected to the other elements over a network.

The nodes (e.g., node X (1122) and node Y (1124)) in the network (1120) may be configured to provide services for a client device (1126). The services may include receiving requests and transmitting responses to the client device (1126). For example, the nodes may be part of a cloud computing system. The client device (1126) may be a computing system, such as the computing system shown in FIG. 11A. Further, the client device (1126) may include or perform all or a portion of one or more embodiments.

The computing system of FIG. 11A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining an input document;
parsing the input document into a plurality of tokens;
generating, by an embedding model, a plurality of token embeddings for the plurality of tokens;
aggregating the plurality of token embeddings across the input document to obtain a document embedding;
performing, by a document prediction model processing the document embedding, a document level classification to obtain a set of document class probabilities comprising an AI generated probability, a mixed probability, and a human generated probability; and
presenting the set of document class probabilities.

2. The method of claim 1, further comprising:
aggregating the plurality of token embeddings across each of at least a subset of sentences in the input document to obtain a plurality of sentence embeddings;
performing, by a sentence prediction model processing the plurality of sentence embeddings and for each of the at least the subset of sentences, a sentence level classification to obtain a plurality of sets of sentence class probabilities comprising the AI generated probability, the mixed probability, and the human generated probability; and
presenting the plurality of sets of sentence class probabilities.

3. The method of claim 1, further comprising:
training an AI detector comprising the embedding model, the document prediction model, and a sentence prediction model, wherein training comprises:
generating a loss from classifying a set of prelabeled training documents comprising AI generated training documents, human generated training documents, and mixed training documents, and
backpropagating the loss through the sentence prediction model, the document prediction model, and the embedding model.

4. The method of claim 1, further comprising:
calibrating the set of document class probabilities for a particular domain of a plurality of domains to obtain a set of output probabilities, wherein the document prediction model is a generically trained model across the plurality of domains,
wherein presenting the set of document class probabilities comprises outputting the set of output probabilities.

5. The method of claim 4, further comprising:
training a document calibration model for the particular domain of the plurality of domains using a domain specific calibration dataset, wherein the domain specific calibration dataset is smaller than a generic training set that trains the document prediction model.

6. The method of claim 1, further comprising:
generating, by an internal token embedding layer of the embedding model, a plurality of internal token embeddings for the plurality of tokens using a value of each of the plurality of tokens;
generating, by a position embedding layer of the embedding model, a plurality of position embeddings for the plurality of tokens using a position of each of the plurality of tokens;
concatenating each internal token embedding of the plurality of internal token embeddings with a corresponding position embedding of the plurality of position embeddings to obtain a plurality of combined embeddings; and
generating, by a transformer layer processing the plurality of combined embeddings, the plurality of token embeddings.

7. The method of claim 1, wherein performing, by the document prediction model processing the document embedding comprises:
performing a first level AI classification to obtain the AI generated probability, the mixed probability, and the human generated probability for the document, and
performing a second level AI classification by a second level AI classifier when the AI generated probability is greater than a threshold, wherein the second level AI classification classifies the document between an entirely AI class and a paraphrased AI class,
wherein presenting the set of document class probabilities comprises presenting a probability of the entirely AI class and the paraphrased AI class.

8. The method of claim 1, wherein performing, by the document prediction model processing the document embedding comprises:
performing a first level AI classification to obtain the AI generated probability, the mixed probability, and the human generated probability for the document, and
performing a second level mixed classification by a second level mixed classifier when the mixed probability is greater than a threshold, wherein the second level mixed classification classifies the document between a human with AI polishing class and a paraphrased AI class,
wherein presenting the set of document class probabilities comprises presenting a probability of the human with AI polishing class and a paraphrased AI class.

9. The method of claim 1, further comprising:
obtaining a human generated training document;
prompting an LLM to generate an AI training document from the human generated training document;
receiving the AI training document from the LLM; and
training the document prediction model with a set of prelabeled training documents comprising the human generated training document and the AI training document.

10. The method of claim 1, further comprising:
obtaining a human generated training document;
prompting an LLM to generate a set of mixed training documents from the human generated training document, the set of mixed training documents each replacing one or more portions of the human generated training document with an AI revised portion; and
training the document prediction model with a set of prelabeled training documents comprising the set of mixed training documents.

11. The method of claim 1, further comprising:
obtaining a human generated training document;
prompting an LLM to generate a set of mixed training documents from the human generated training document, the set of mixed training documents each replacing one or more portions of the human generated training document with an AI rewritten portion; and
training the document prediction model with a set of prelabeled training documents comprising the set of mixed training documents.

12. The method of claim 1, further comprising:
obtaining, from an LLM, a topic of a human section of a human generated training document;
obtaining, from an AI model, a new AI section to replace the human section to generate a first mixed training document;
obtaining, from the AI model, an edit of the human section to generate a second mixed training document; and
training the document prediction model with a set of prelabeled training documents comprising the set of mixed training documents.

13. The method of claim 1, further comprising:
augmenting at least one training document in a set of prelabeled training documents to add a mistake into the at least one training document; and
training the document prediction model with the set of prelabeled training documents.

14. The method of claim 1, further comprising:
normalizing at least one training document in the set of prelabeled training documents to remove an AI generation artifact; and
training the document prediction model with the set of prelabeled training documents.

15. The method of claim 1, further comprising:
obtaining a plurality of features for human generated training documents and AI generated training documents;
clustering the plurality of features into a first plurality of clusters for the human generated class and a second plurality of clusters for the AI generated class;
extracting, for each cluster of the first plurality of clusters and the second plurality of clusters, a representative feature to form a human generated class feature set and an AI generated class feature set; and
obtaining a natural language explanation for the human generated class feature set and the AI generated class feature set.

16. The method of claim 15, further comprising:
training a classifier model to differentiate between human and AI text based on the class feature sets to obtain a prominence of each of a subset of features in the human generated class feature set and the AI generated class feature set; and
filtering the in the human generated class feature set and the AI generated class feature set according to the prominence to obtain a filtered human generated class feature set and a filtered AI generated class feature set,
presenting an explanation for at least one feature in the filtered feature sets.

17. A system comprising:
at least one computer processor; and
an AI detector executing on the at least one computer processor for performing a plurality of operations comprising:
obtaining an input document,
parsing the input document into a plurality of tokens,
generating, by an embedding model, a plurality of token embeddings for the plurality of tokens,
aggregating the plurality of token embeddings across the input document to obtain a document embedding,
performing, by a document prediction model processing the document embedding, a document level classification to obtain a set of document class probabilities comprising an AI generated probability, a mixed probability, and a human generated probability, and
presenting the set of document class probabilities.

18. The system of claim 17, wherein the plurality of operations further comprises:
aggregating the plurality of token embeddings across each of at least a subset of sentences in the input document to obtain a plurality of sentence embeddings,
performing, by a sentence prediction model processing the plurality of sentence embeddings and for each of the at least the subset of sentences, a sentence level classification to obtain a plurality of sets of sentence class probabilities comprising the AI generated probability, the mixed probability, and the human generated probability, and
presenting the plurality of sets of sentence class probabilities.

19. The system of claim 17, wherein the plurality of operations further comprises:
training an AI detector comprising the embedding model, the document prediction model, and a sentence prediction model, wherein training comprises:
generating a loss from classifying a set of prelabeled training documents comprising AI generated training documents, human generated training documents, and mixed training documents, and
backpropagating the loss through the sentence prediction model, the document prediction model, and the embedding model.

20. A method comprising:
obtaining an input document;
parsing the input document into a plurality of tokens;
generating, by an embedding model, a plurality of token embeddings for the plurality of tokens;
aggregating the plurality of token embeddings across each of at least a subset of sentences in the input document to obtain a plurality of sentence embeddings;
performing, by a sentence prediction model processing the plurality of sentence embeddings and for each of the at least the subset of sentences, a sentence level classification to obtain a plurality of sets of sentence class probabilities comprising an AI generated probability, a mixed probability, and a human generated probability; and
presenting the plurality of sets of sentence class probabilities.
